(19) United States
(12) Patent Application Publication
(10) Pub. No.: US 2008/0065531 A1
(43) Pub. Date: Mar. 13, 2008

(54) WEB-BASED PAYMENTS ON TEXT-TO-PAY SMS NETWORKS

(76) Inventors: Steven B. Smith, Holladay, UT (US); Nicholas A. Thomas, Orem, UT (US)

Correspondence Address: KIRTON AND MCCONKIE, 60 EAST SOUTH TEMPLE,, SUITE 1800, SALT LAKE CITY, UT, 84111, US

(21) Appl. No.: 11/460,023

(22) Filed: Jul. 26, 2006

(51) Int. Cl. G06Q 40/00

(52) U.S. Cl. 705/39

(57) ABSTRACT

A web-based financial software application that emulates short message service (SMS) based text payment. The software allows entry of financial transactions in detailed form to allow for normal budgeting, accounting, and tracking methods, then translates the pending transaction from the detailed form into a text-based format compatible with the SMS payment network and transmits and confirms the payment as would normally be done via a mobile device. Optionally, the transmission of the text-based payment may occur through a secure link to simplify the payment process. The software also permits entry of transactions in the SMS-compatible format and translates these entries into a detailed form to allow for budgeting, accounting, and tracking. The software then searches for corresponding payees, and allows the user to select from found matching payees to automatically fill in the remaining payee information, or permits the user to manually enter additional information.

### BACKGROUND OF THE INVENTION

1. Field of the Invention

The present invention relates to financial systems and text-to-pay short message service (SMS) networks, and more particularly to leveraging the text-to-pay SMS networks from a web site or other financial services application.

2. Background and Related Art

The advent of mobile phones and devices capable of transmitting short text messages in almost any situation has led to the development of several additional industries making use of these capabilities. One of these industries is the so-called “text-to-pay” industry, where users text short messages such as “pay 45 to 5145556555” or “send 45 to 5145556555” to a service provider's number. The service provider, after confirmation of the identity of the sender, then debits the sender's account for the defined amount (here $45) and pays that amount to the designated payee (here the owner of the phone number (514) 555-6555 (a fictional number)).

These payments or transfers are advantageous because they can be initiated in practically any situation, whether the user has cash on hand or not, based on funds in a linked account maintained by the user at the service provider. Besides simple direct payments from one person to another, this capability is also being used to allow shopping-like experiences from one's mobile phone. For example, a concertgoer might desire a souvenir from a concert, but not have the patience to stand in line to order an item. Rather than wait in line, the concertgoer can simply text message a code word to a particular text message number, and upon confirmation of the order the selected item will be shipped to the concertgoer.

While these networks and industries have their advantages, they have several severe disadvantages. First, while these networks and industries are powerful tools in situations where the user has access to a phone with text messaging capabilities, there are many situations where the user does not have access to a SMS-enabled phone or does not desire to incur the costs typically associated with the sending of the text message. For some phone providers, individual text messages can cost as much as ten cents per message, and the use of such systems can lead to great costs over time.

A second set of problems is particularly problematic for less-disciplined users. First, as can be seen from the content of the typical message sent to initiate payment, “send 45.00 to 4155551234”, very little information about the transaction or its intent is contained in the message. For frequent users, a string of such messages would be nearly incomprehensible when trying to discern what went to whom and why. Second, because these methods use remote accounts to facilitate payment, a user can easily spend or attempt to spend more than desired or more than is in the corresponding account. Finally, in a related problem, these systems do not provide a related and accessible financial budgeting, accounting, and tracking solution that allows the user to maintain control over spending. Thus, what is needed is a solution that addresses these problems.

### BRIEF SUMMARY OF THE INVENTION

The present invention relates to a computer based system and method for emulating text-based payments and transactions from within a robust financial software package. The software package may be web-based or based on an individual computing device that is connected at least intermittently to a network for transmission of generated text-based payments. The system allows for entry of a financial transaction in a standard form, including payee information and transaction purpose, to allow for normal accounting and tracking methods. The system then translates the pending transaction from the standard form into a text-based format compatible with the text-based payment network and transmits and confirms the payment as would normally be done via a mobile device. In a web-based version, these features are available to mobile devices, such as smart phones, laptop and notebook computers, and PDAs that are capable of connection to the Internet or other similar network.

The present invention also provides for the entry of text-based payments and transactions into a financial accounting software system for tracking and conversion into a standard financial transaction form. This allows standard tracking and accounting to take place using the very simple information contained in text-based transactions. The user inputs the text string corresponding to a transaction, and the financial software system translates the data into a useful form by converting the known information into fields corresponding to amount, date, and some payee information, then looks up corresponding payees from which the user may select to fill in the remaining payee information. If no payee information is available, the user may manually enter that information, and manually enters other transaction data, such as purpose of the transaction. The transaction is then in a format that is more useful for tracking and accounting purposes than the original short text message is.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows a representative system that provides a suitable operating environment for use of the present invention.

FIG. 2 is a flow chart that provides a representative method for using a financial application and a text-based network system to generate an information-rich financial transaction and make payment via the text-based network system.

FIG. 3 is a flow chart that provides a representative method for converting a text-based payment message into an information rich financial transaction entry in a financial application.

### DETAILED DESCRIPTION OF THE INVENTION

Referring now to the figures, a description of the embodiments of the present invention will be given. It is expected that the present invention may take many other forms and shapes, hence the following disclosure is intended to be illustrative and not limiting, and the scope of the invention should be determined by reference to the appended claims.

The following disclosure of the present invention is grouped into three subheadings, namely “Exemplary Operating Environment,” “Web-Based Emulation of Text-to-Pay Networks,” and “Translation of Text Message Protocol Transactions into Information-Rich Financial Entries.” The utilization of the subheadings is for convenience of the reader only and is not to be construed as limiting in any sense.

### Exemplary Operating Environment

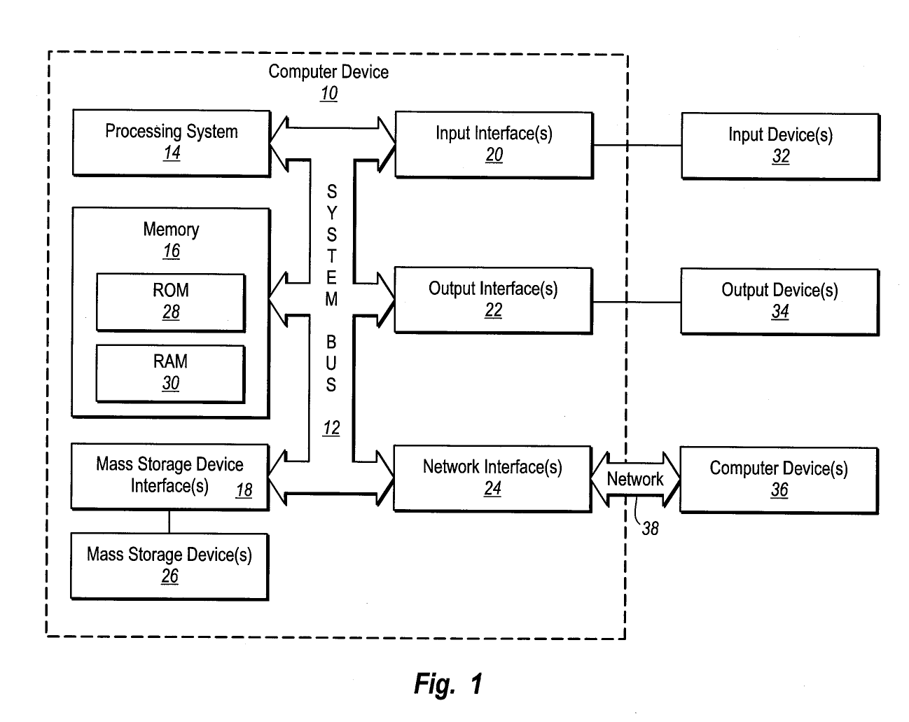

FIG. 1 and the corresponding discussion are intended to provide a general description of a suitable operating environment in which the invention may be implemented. One skilled in the art will appreciate that the invention may be practiced by one or more computing devices and in a variety of system configurations, including in a networked configuration.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing the invention includes computer device 10, which may be a general-purpose or special-purpose computer. For example, computer device 10 may be a personal computer, a laptop or notebook computer, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a monitor or display screen, a speaker, a printer, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

### Web-Based Emulation of Text-to-Pay Networks

One embodiment of the present invention utilizes the capabilities of web-enabled computing devices networked to the Internet through a wired or wireless connection, one such example being the operating environment described above. Common examples of computing devices that could be used with the present invention include “smart” phones, PDAs, laptops and notebooks, and any other stationary or mobile computing device capable of accessing the world wide web (“web”). The present invention is capable of use with any number of programs designed to access the web (“browsers”) that are commonly known in the art and adapted for use with the particular device being used to access the web for the present invention. As such, these programs are not described further. While the foregoing description relates exclusively to a web-based embodiment of the present invention, it is anticipated that the techniques and methods described may be embodied advantageously in a non-web-based but networked computer application.

The present invention provides web-based emulation of text-to-pay networks in conjunction with web-based financial software to address the shortcomings of such networks discussed above. The web-based financial suite may include the capabilities of tracking financial accounts and expense tracking as disclosed in U.S. patent application Ser. No. 10/677,608 filed Oct. 2, 2003 and published as Publication No. 2005/0075975, the disclosure of which is incorporated herein in its entirety by reference. In a web-based financial program, a user has a user account that allows the user to access the financial program and his or her records in the program. The user may opt to monitor the funds in at least one of the user's individual accounts maintained at a financial institution, or the user may choose to create categories of spending within an account or over several accounts (“virtual accounts”) to monitor more closely. This provides great flexibility to the user in budgeting and monitoring expenditures. One way this can be done is to create envelopes corresponding to accounts or virtual accounts with individual budgets and tracked expenditures.

The web-based financial software also allows the user to designate and describe payees so that when expenditures are incurred, they may be entered into the financial software in such a way that the user will easily be able to remember the details of the expenditure. Alternatively, the software may be used to initiate an expenditure by selecting a payee from the list of payees the user has designated and described within the software, selecting the amount, and selecting the purpose of the transaction. Then the software may initiate the payment in any number of pre-designated ways to complete the transaction. This may include payment by e-mail, online bill payment, electronic transfer, or any other means known in the art. Because the payment was initiated from within the web-based financial software, it is simple for the software to track the expenditure and its purpose. Of course, through either method the user may assign the expenditure to any one of the user's actual or virtual accounts, the transaction may initially be entered as a pending transaction rather than a completed transaction, and when actual account statements arrive any pending transactions may be matched with completed transactions to facilitate proper budgeting and accounting.

The present invention provides the added benefit of allowing the web-based emulation of text-to-pay networks through the advantageous and powerful interface of the web-based financial software. In a standard text-to-pay network, the user interface is severely limited by the text-only display and entry options, as well as the functionality of most SMS-enabled devices, which only allow display of one function at a time. For example, while an example text message payment of “send 12.75 to 4155551234” seems deceptively simple, to send this message the user must know the phone number of the person to whom the payment is being sent. Most people are notoriously bad at memorizing and remembering long strings of numbers such as this, and hence many people store long lists of numbers in their cell phones for easy access according to the name of the person to be called. Thus to generate this message, the cell phone user must search through a database of names for the person to whom payment will be sent, find the corresponding telephone number, and remember it long enough to exit the name listings, begin a text message that includes the entry of another lengthy number (the number of the payment service facilitating the text-based payment), and prepare the simple-seeming text payment message. Similar problems occur when directing such payments to e-mail addresses.

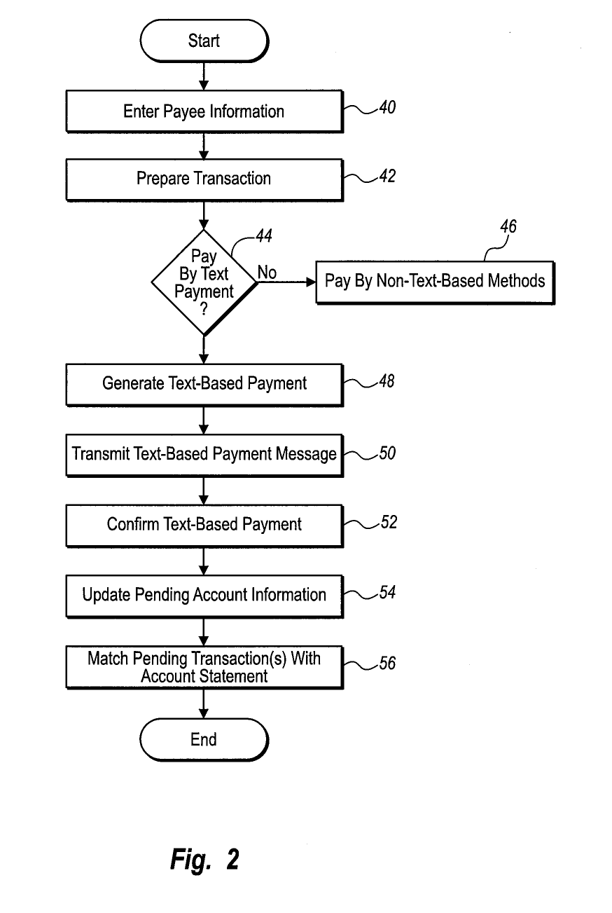

The present invention solves this problem simply and efficiently, as can be seen with reference to FIG. 2. FIG. 2 shows a flow chart illustrating making a payment through the web-based financial software and web-based simulation of the text-to-pay network. The process begins at step 40, where the user enters in payee information. This step may occur at any time prior to the initiation of a text-based payment, may occur concurrently with a text-based payment, or may even optionally occur after a text-based payment has been sent, as will be described below. The entry of the payee information occurs as it would in almost any financial tracking software, with several important distinctions. First, the entry of payee information at step 40 normally includes the entry of a telephone number or e-mail address of the person to receive the text-based payment. This is in contrast to many financial situations, where the address to which a check is to be sent is the most important piece of information. Second and optionally, the entry of payee information may include the entry of a designation indicating the individual is capable and/or willing to receive payment by text-based payment systems. Of course, the entry of payee information may occur repeatedly to input any number of designated payees.

After the entry of payee information at step 40, flow next proceeds to the preparation of a transaction at step 42. In preparing a transaction, the user selects a payee from a list of payees whose information is already contained in the web-based software interface, or enters in a new payee simultaneously with the preparation of the transaction, combining steps 40 and 42. The user also selects an amount for the transaction, and optionally can select a purpose or description. This is a major advantage over standard text-to-pay systems, which are generally limited to near-meaningless information strings containing only the amount and the phone number or e-mail of the recipient. The emulation of the text-based payment networks occurs when the user selects a text-based method of payment at decision block 44. The user is free to select to pay by non-text-based payment methods, as illustrated at step 46, in which case payment would proceed by issuance of a check, initiation of a wire transfer, or by other payment means available and known in the art. However, if the user elects to proceed via a text-to-pay system, flow proceeds to the preparation of a text-based payment at step 48.

To emulate the text-based payment systems, the web-based financial suite generates a text-based payment text string at step 48. This payment text string emulates the text strings that would be entered by a user in a normal text-messaging environment, that is, “send 44.50 to 4150001234”. In this process, the web-based financial software eliminates all data unnecessary for the initiation of actual payment, such as information concerning the identity of the payee (payee name), the purpose of the transaction, and other information that may be available about the transaction contained in the financial suite. This information is not lost, however, as it remains contained within the web-based financial software suite and may be linked to the generated text-based payment.

In some instances, the automatic text-based payment string that is or would be generated by the web-based financial application in step 48 based solely on payee and amount would not be the proper one to execute the financial transaction desired by the user. For example, some text-based payment systems allow the sales of items by sending a text-message code to a certain recipient. For example, one sample message might simply be “JUICED” sent to a certain number to purchase a case of energy-enhancing beverage. Because the number of available items for purchase in this fashion is large and potentially ever-changing, the format of the text message required might not be easily automatically generated by the web-based financial application. In such cases, the application might allow the user to manually enter the text message to be sent and the recipient phone number or text message number.

Alternatively, the web-based financial application might be modified to include a web-based store. In this case, clicking on an item would automatically generate the proper text message and a financial transaction entry in the application with some details entered. The user would then enter additional details and complete the transaction as detailed below. The user would then be able to take advantage of the web-based financial application's additional budgeting and accounting features as discussed below as well.

After generation of the payment message at step 48, the message is then transmitted at step 50 and confirmed at step 52. Currently, text-based payment systems ensure security by completing payment in two steps. First, the user creates the text message containing payment instructions and sends it to the service provider, and second, the payment service provider requires payment confirmation, such as by calling the user back and requesting an authorization code or personal identification number (PIN). The web-based financial system may operate in this fashion, or may facilitate payment in a single step.

In a two-step system, the financial suite generates the text-based payment message at step 48 and transmits it at step 50. The transmission is facilitated by the network/web-connected nature of the suite and the user's entry device. The transmission may be encrypted through a server, or may even be sent over a telephone connection initiated by the web-based financial system service provider. The text-to-pay service provider then contacts the user as in standard text payment systems, and the user confirms payment by providing an authorization code/PIN at step 52. This method is especially applicable for users accessing the web-based financial suite through today's powerful “smart” phones, and who would have immediate access to their phones to respond to the telephone authentication request.

The financial suite allows simplification of this process, however, by eliminating the need for a second payment confirmation step 52. Because the web-based financial suite involves the financial dealings of the user, entry into the financial suite requires separate authentication of the user by username and/or password. Thus the security provided by the second step of user authentication by standard text payment systems has already been provided by the web-based financial system service provider. In such systems, it is anticipated that a secure link would be provided between the web-based financial system service provider and the text payment service provider to enhance security of the transmitted payment instructions. In such systems, the web-based financial system service provider and the text payment service provider might mutually advertise compatibility, partnership, or a client relationship to mutually benefit one another and encourage use of the systems. Thus, in such a system, the steps of transmission of the text-based payment message 50 and the confirmation of the text-based payment 52 may be combined.

In some instances, the user may not have a connection to the web or a network at the time of initial entry of the financial transaction discussed above. Such often occurs with wireless devices such as smart phones, where connectivity often depends on the robustness of the wireless network in which the user finds him or herself, or in embodiments implemented in a non-web-based application and computer with only intermittent network connectivity. In such situations, the web-based financial application or non-web-based financial application may generate the text-based payment message according to step 48 but not initiate transmission and confirmation of the payment message according to steps 50 and 52 until a later time. The application would however allow the performance of later actions, such as the assignment of the pending transaction to various virtual and actual accounts. Then, when a later connection is established, the application would automatically complete the steps of transmission 50 and confirmation 52, as detailed above.

Regardless of the timing of the actual transmission and confirmation to the text-to-pay service provider or text-based payment provider, the receipt and confirmation of the generated text message initiates payment of the specified amount to the specified individual. The text-to-pay provider interprets the method as is known in the art, and debits the user's text-to-pay account in an amount specified in the text message. The provider then makes payment in an acceptable form to the person who owns the corresponding phone number or e-mail address, also as known in the art.

As mentioned above, occasionally the entry of payee information at step 40 may occur after the preparation, transmission, and confirmation of a text-based payment at steps 42, 48, 50, and 52. This might be the case when a user needs to initiate a payment very quickly and does not have time to enter payee information prior to the initiation of a payment. In this situation, the web-based financial system would allow the entry of a standard text-based payment text string, such as “send 23.19 to 4150004321”. The system would transmit and confirm the payment as discussed above, and would enter the transaction in the web-based financial software as a pending transaction with a notation that additional data is desirable. The user could then enter the corresponding payee information from step 40 at a more convenient later time. Even if the information were not entered until much later or not at all, many of advantages of the present invention would be maintained, as can be seen from the following discussion.

In standard text-based payment systems, the steps would end upon confirmation of the payment at step 52, although financially-wise users would keep track of their payments through the entry of the payment into some sort of financial accounting system, software or otherwise. However, the web-based financial system provides additional advantages over traditional text-based payment systems in that the transaction information is already entered for additional tracking and accounting. For example, by selecting to pay by text payment at step 44, the user might have the web-based financial software automatically create a pending deduction on an envelope, virtual account, or other data structure corresponding to the account from which the payment will be deducted.

The user might also select, prior to or upon completion of the transaction, to assign the transaction to other virtual accounts, such as an account set up for a particular class of expenditures (groceries, automobile expenses, leisure, etc.). This allows the user to update budgets in various classes of funds nearly simultaneously with the initiation of a text-based payment, while the purposes for the payment and transaction are fresh in the user's mind. These actions occur at step 54 of updating pending transaction and account information.

Furthermore, the current invention and web-based financial system allow final reconciliation of pending transactions once they clear the text-based payment account at step 56. At this point, the benefits of the present invention become clear, as the user is provided with a statement that includes minimal information such as date, amount, and phone number or e-mail to which payment was made. Because the web-based financial suite includes all this information as well as the originally-entered additional data, it is a simple matter for the user to match the minimal information provided on the statement with the detailed information contained within the web-based financial software system. The user can then select the transaction as having cleared, and the web-based financial suite automatically finalizes the information for budgeting and accounting purposes. Of course, these steps may be repeated as necessary for additional transactions.

### Translation of Text Message Protocol Transactions into Information-Rich Financial Entries

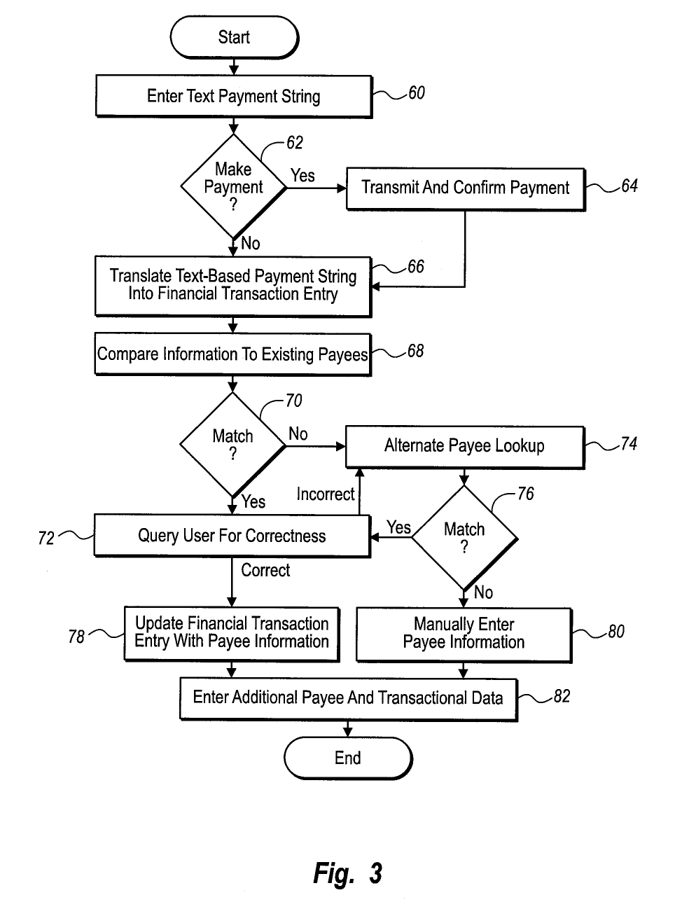

As mentioned above, occasionally the entry of payee information at step 40 may occur after the completion of a text-based payment transaction. In such cases, the only data entered into the web-based financial suite is the text string corresponding to the transaction, such as “send 45.20 to 4150001234”. Sometimes, even if payee information already exists in the web-based financial system, the user might simply not have enough time to enter in a full transaction at that time and might decide to connect the text string to the payee information later. Other times, the user might not have access to a web-accessible environment when a payment is desired, and might only have a text-enabled telephone from which to send a payment. The present invention also includes translation of text-based payment strings into more useful information-rich financial entries within the web-based financial suite, as illustrated by the flow chart in FIG. 3.

If the user did not have access to the web-based financial system upon initiation of the text-based payment, the user would be able to enter the payment into the web-based financial software package by simply searching through sent messages on the text-enabled phone or other text system, and entering the text string into the web-based financial package. Whether the payment was initiated from within the web-based financial package or is entered later as merely a record of a transaction, the process starts at step 60 with the entry of the text payment string. The process then proceeds to decision block 62, where the user determines if payment is to be made based upon the entered text string or if the payment is merely an entry of a past transaction. If payment is to be made, execution proceeds to step 64, where payment is transmitted and confirmed, as described above.

If payment is not to be made, or after payment has been made, execution then proceeds to step 66, which is the translation of the text-based payment text string into a financial transaction entry. In this step, the web-based financial application converts the information contained in the text string into more familiar financial transaction data. For example, the text string “send 10.60 to 4150001234” would be converted so that the transaction would have (415) 000-1234 entered as the payee telephone number, $10.60 entered as the amount, and might additionally have the date the transaction was entered as well. As another example, the text string “pay 12.44 to user@domain.com” would be converted so that the transaction would have user@domain.com entered as the payee e-mail address, $12.44 entered as the amount, and might also additionally have an associated date.

After translation of the text-based payment string, execution then proceeds to step 68, where the translated information is compared to the existing payee database to see if a matching payee can be found. If a match is found at decision block 70, the web-based financial package queries the user at step 72 to determine if the matching payee is the correct payee. If there is no payee match found at decision block 70, execution proceeds instead to step 74 where the web-based financial application performs an alternate payee lookup. This lookup may involve searching through a personal information management application of the user searching for matching contacts, or it may involve a web-based reverse number lookup based on the information obtained from step 66. If a potential match is found at decision block 76, execution proceeds to step 72, where the user is queried as to the correctness of the potential match.

If a proper match is found at step 72, execution proceeds to step 78, where the web-based financial application updates the financial transaction entry with the payee information contained in the matching record found in step 68 or step 74. If the potential match is incorrect, execution then proceeds or returns to step 74 to attempt an alternate payee lookup. If no proper match is found at either step 68 or step 74, execution then proceeds to step 80, where the user may manually enter payee information. In performing this entry, or accepting any match found, the payee information database of the web-based financial application may be updated to reflect the additional or updated payee. Finally, whether the payee information is updated through a found match at step 78 or manually at step 80, execution then proceeds to step 82, where the user may enter additional payee or transaction data, such as the purpose of the transaction and assigning of the transaction to one or more actual or virtual accounts, as discussed above.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A method of emulating short-message-service-based text payments with a financial software application, the method comprising:
providing a short-message-service-based text payment provider;
providing a user with a text payment user account with the short-message-service-based text payment provider;
providing a financial software application running on a computer system;
entering a payee's information into the financial software application, the payee's information including at least one of:
the payee's telephone number; and
the payee's electronic mail address;
using the financial software application to prepare a transaction to be paid to the payee from the user's account;
generating a text string corresponding to the transaction and compatible with a text-based payment system of the short-message-service-based text payment provider, the text string directing the short-message-service-based text payment provider to perform the transaction, the text string including an amount of the transaction and at least one of:
the payee's telephone number; and
the payee's electronic mail address; and
providing payment to the payee from the user's text payment user account according to the information contained in the text string.

2. The method of claim 1 wherein the financial software application is web based and the user has a financial software account on the financial software application.

3. The method of claim 2 wherein the step of providing payment to the payee comprises:
transmitting the text string to the short-message-service-based text payment provider; and
confirming the transaction directed by the text string to the short-message-service-based text payment provider.

4. The method of claim 3 wherein the web-based financial software application and the short-message-service-based text payment provider are linked with a secure data link.

5. The method of claim 4 wherein the steps of transmitting the text string to the short-message-service-based text payment provider and confirming the transaction directed by the text string occur over the secure data link.

6. The method of claim 3 wherein the step of transmitting the text string to the short-message-service-based text payment provider occurs by the transmission of a text message over standard text messaging communication lines.

7. The method of claim 1 further comprising:
entering the transaction as a pending transaction in the financial software application;
providing the user with a statement from the short-message-service-based text payment provider showing the payment from the user account with the short-message-service-based text payment provider; and
matching the pending transaction in the financial software application to the payment from the user account with the short-message-service-based text payment provider.

8. A method of leveraging text-to-pay networks from a website comprising:
providing a financial services website;
providing a user with a user account on the financial services website;
providing a text-based payment provider;
providing the user with a user account on the text-based payment provider;
monitoring the user's text-based payment account with the user account on the financial services website;
entering a payee's information into the financial services website, the information including at least one of:
the payee's telephone number; and
the payee's electronic mail address;
using the financial services website to prepare a transaction to be drawn on user's text-based payment account, the transaction including entries for the payee and an amount;
generating a text string corresponding to the transaction and corresponding to a text-based payment from the user's text-based payment account that includes the amount and at least one of:
the payee's telephone number; and
the payee's electronic mail address;
transmitting the text string to the text-based payment provider;
confirming the payment of the text-based payment corresponding to the transmitted text string; and
completing payment of the text-based payment from the user's text-based payment account to the payee according to the text string.

9. The method of claim 8 wherein the financial services website and the text-based payment provider are linked via a secure data link.

10. The method of claim 9 wherein the steps of transmitting the text string and confirming the payment occur through the secure data link.

11. The method of claim 8 wherein the step of transmitting the text string occurs by the transmission of a text message over standard text messaging communication lines.

12. The method of claim 8 further comprising:
entering the transaction as a pending transaction in the user account on the financial services website;
providing the user with a statement from the text-based payment provider showing the payment from the user account on the text-based payment provider; and
matching the pending transaction in the user account on the financial services website to the payment from the user account on the text-based payment provider.

13. A method of converting a short-message-service-based text payment transaction into an information-rich financial entry in a financial software application comprising:
providing a short-message-service-based text payment provider;
providing a user with a text payment user account with the short-message-service-based text payment provider;
providing a financial software application running on a computer system;
providing a text string to the short-message-service-based text payment provider, the text string corresponding to an instruction to the provider to make a payment from the user's account to a payee, the text string including an amount of the payment and at least one of:
the payee's telephone number; and
the payee's electronic mail address;
providing the text string to the financial software application;
translating the text string into a financial transaction entry in the financial software application, the financial transaction entry including entries for amount and at least one of:
the payee's telephone number; and
the payee's electronic mail address; and
adding at least one of additional payee information and additional transaction information to the financial transaction entry in the financial software application.

14. The method of claim 13 wherein the step of adding at least one of additional payee information and additional transaction information comprises:
performing a search for payee records whose information matches the payee information contained in the translated text string; and
updating the transaction with additional payee information if a properly matching payee record with more payee information is found.

15. The method of claim 14 wherein the step of performing a search for payee records whose information matches the payee information contained in the translated text string comprises:
comparing the at least one of the payee's telephone number and the payee's electronic mail address translated from the text string to telephone numbers and electronic mail addresses in the payee records to determine if the at least one of the payee's telephone number and the payee's electronic mail address translated from the text string match at least one of a telephone number and an electronic mail address in a payee record;
notifying the user if a match is found; and
querying the user if the match is for a correct payee.

16. The method of claim 14 wherein the payee records comprise records selected from the group of:
payee records previously entered into the financial software application;
payee records contained in a personal information management application accessible to the financial software application; and
payee records contained in a searchable records database wherein the records may be searched by at least one of:
a telephone number; and
an electronic mail address.

17. The method of claim 16 wherein the searchable records database is a database accessible via the Internet.

18. The method of claim 13 wherein the financial software application is web-based.

19. The method of claim 13 wherein the step of adding at least one of additional payee information and additional transaction information comprises adding information about the purpose of the financial transaction.

20. The method of claim 13, further comprising:
marking the financial transaction entry as a pending transaction in the financial software application;
providing the user with a statement from the short-message-service-based text payment provider showing the payment from the user account with the short-message-service-based text payment provider; and
matching the pending transaction in the financial software application to the payment from the user account with the short-message-service-based text payment provider.
